(19) United States
(12) Patent Application Publication
(10) Pub. No.: US 2016/0112713 A1
(43) Pub. Date: Apr. 21, 2016

(54) MAPPING SPHERICAL IMAGE TO 2D REPRESENTATIONS

(71) Applicant: Google Inc., Mountain View, CA (US)

(72) Inventor: Andrew Ian Russell, San Jose, CA (US)

(21) Appl. No.: 14/518,779

(22) Filed: Oct. 20, 2014

(51) Int. Cl. H04N 19/46; H04N 19/91; H04N 19/136; H04N 19/18; H04N 19/20; H04N 19/107

(52) U.S. Cl. CPC H04N 19/46; H04N 19/20; H04N 19/107; H04N 19/136; H04N 19/18; H04N 19/91

(57) ABSTRACT

Disclosed is a method for encoding a spherical video. The method can include mapping a frame of a spherical video to a first two dimensional representation based on a spherical to square projection, the first two dimensional representation being a square, mapping the first two dimensional representation to a second two dimensional representation, the second two dimensional representation being a rectangle, and encoding the second two dimensional representation as an encoded bit stream.

### FIELD

Embodiments relate to encoding and decoding a spherical image and a spherical video.

### BACKGROUND

Typically, encoders and decoders operate on a two dimensional (2D) palette when encoding images and/or frames of a video. Spherical images and videos are three dimensional, therefore, a conventional encoders and decoders are not capable of encoding/decoding spherical images and video.

### SUMMARY

Example embodiments describe techniques for converting spherical images and video to 2D representations and leveraging special characteristics of the 2D representations during encoding/decoding of the images and/or frames of a video.

In a general aspect, a method for encoding a spherical video can include mapping a frame of a spherical video to a first two dimensional representation based on a spherical to square projection, the first two dimensional representation being a square, mapping the first two dimensional representation to a second two dimensional representation, the second two dimensional representation being a rectangle, and encoding the second two dimensional representation as an encoded bit stream.

Implementations can include one or more of the following features. For example, the spherical to square projection can be a Peirce quincuncial projection. For example, during an intra-prediction process, the method can include determining whether a block to be encoded is on a boundary of the second two dimensional representation, and upon determining the block to be encoded is on the boundary, select an adjacent end block as a template, the adjacent end block being other than a left reconstructed block or an upper reconstructed block of the block to be encoded. The method can further include determining whether a block to be deblocked is on a boundary of the two dimensional representation, and upon determining the block to be deblocked is on the boundary, select an adjacent end block as a comparison block, the adjacent end block being other than a left reconstructed block or an upper reconstructed block of to the block to be deblocked.

For example, the second two dimensional representation is formed of two squares with equal length sides, and the two squares generated from the first two dimensional representation. The mapping of the first two dimensional representation to the second two dimensional representation can include determining a first square with corners that intersect each side of the first two dimensional representation equidistant from the corners of the first two dimensional representation, determining four triangles each having a side in contact with a different side of an inner circle of the frame of the spherical video, generating a second square based on the four triangles, and generating the second two dimensional representation based on the first square and the second square. The method can further include generating a look-up table indicating a position of at least one corresponding adjacent end block.

For example, the encoding of the second two dimensional representation can include generating at least one residual by subtracting a template from un-encoded pixels of the block to be encoded, encoding the at least one residual by applying a transform to a residual block including the at least one residual, quantizing transform coefficients associated with the encoded at least one residual, entropy encoding the quantized transform coefficients as a compressed video bit stream, and transmitting the compressed video bit stream including a header indicating a intra-frame coding mode, the intra-frame coding mode indicating a technique used during the mapping of the frame of the spherical video to the two dimensional representation.

In a general aspect, a method for decoding a spherical video can include receiving an encoded bit stream including a header indicating a projection technique used during a conversion of a frame of a spherical video to a first two dimensional representation, decoding the first two dimensional representation, mapping the first two dimensional representation to a second two dimensional representation, the first two dimensional representation being a rectangle and the second two dimensional representation being a square, and mapping the second two dimensional representation to a frame of the spherical video based on a spherical to square projection.

Implementations can include one or more of the following features. For example, the spherical to square projection is a Peirce quincuncial projection. During an intra-prediction process, the method can further include determining whether a block to be decoded is on a boundary of the first two dimensional representation, and upon determining the block to be decoded is on the boundary, select an adjacent end block as a template, the adjacent end block being other than a left reconstructed block or an upper reconstructed block of the block to be encoded.

For example, the method can further include determining whether a block to be deblocked is on a boundary of the two dimensional representation, and upon determining the block to be deblocked is on the boundary, select an adjacent end block as a comparison block, the adjacent end block being other than a left reconstructed block or an upper reconstructed block of to the block to be deblocked. The first two dimensional representation is formed of two squares with equal length sides. For example, the mapping of the first two dimensional representation to the second two dimensional representation can include generating a first square and a second square based on the first two dimensional representation, determining four triangles from the second square each of the triangles having a side of the second square, and repositioning three of the four triangles to form a third square as the second two dimensional representation.

The method can further include generating a look-up table indicating a position of at least one corresponding adjacent end block. The decoding of the first two dimensional representation can include entropy decoding the encoded bit stream to generate quantized encoded transform coefficients, de-quantizing the quantized encoded transform coefficients to generate encoded transform coefficients, applying a transform to the encoded transform coefficients to generate at least one reconstructed prediction residual, and adding the at least one reconstructed prediction residual to a prediction block associated with the matched template to reconstruct a pixel block.

In a general aspect a non-transitory computer-readable storage medium having stored thereon computer executable program code which, when executed on a computer system, causes the computer system to perform steps including mapping a frame of a spherical video to a first two dimensional representation based on a spherical to square projection, the first two dimensional representation being a square, mapping the first two dimensional representation to a second two dimensional representation, the second two dimensional representation being a rectangle, and encoding the second two dimensional representation as an encoded bit stream.

Implementations can include one or more of the following features. For example, during an intra-prediction process, the steps can further include determining whether a block to be encoded is on a boundary of the second two dimensional representation, and upon determining the block to be encoded is on the boundary, select an adjacent end block as a template, the adjacent end block being other than a left reconstructed block or an upper reconstructed block of the block to be encoded. The steps further include determining whether a block to be deblocked is on a boundary of the two dimensional representation, and upon determining the block to be deblocked is on the boundary, select an adjacent end block as a comparison block, the adjacent end block being other than a left reconstructed block or an upper reconstructed block of to the block to be deblocked.

The mapping of the first two dimensional representation to the second two dimensional representation can include determining a first square with corners that intersect each side of the first two dimensional representation equidistant from the corners of the first two dimensional representation, determining four triangles each having a side in contact with a different side of an inner circle of the frame of the spherical video, generating a second square based on the four triangles, and generating the second two dimensional representation based on the first square and the second square.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1A illustrates a video encoder system according to at least one example embodiment.

FIG. 1B illustrates a video decoder system according to at least one example embodiment.

FIG. 2A illustrates a flow diagram for a video encoder system according to at least one example embodiment.

FIG. 2B illustrates a flow diagram for a video decoder system according to at least one example embodiment.

FIG. 3 illustrates a two dimensional (2D) representation of a sphere according to at least one example embodiment.

FIG. 4A illustrates a spherical image according to at least one example embodiment.

FIGS. 4B and 4C illustrate a block diagram of a 2D square representation of a spherical video frame(s)/block(s) or image/block(s) according to at least one example embodiment.

FIG. 4D illustrates a block diagram of a 2D rectangle representation of a spherical video frame(s)/block(s) or image/block(s) according to at least one example embodiment.

FIG. 4E illustrates a look up table (LUT) according to at least one example embodiment.

FIG. 4F illustrates a look-up table according to at least one example embodiment.

FIG. 5 is a flowchart of a method for mapping a spherical frame/image to a 2D representation of the spherical frame/image according to at least one example embodiment.

FIGS. 6 and 7 are flowcharts of a method for encoding/decoding a video frame according to at least one example embodiment.

FIG. 8 is a flowchart of a method for converting a 2D representation of a spherical image to a spherical frame/image according to at least one example embodiment.

FIGS. 9A and 9B are flowcharts for a method of operating a deblocking filter according to at least one example embodiment.

FIG. 10 is a schematic block diagram of a computer device and a mobile computer device that can be used to implement the techniques described herein.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

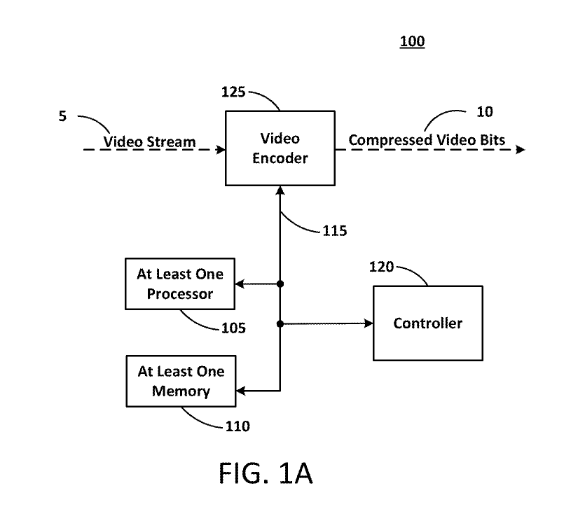

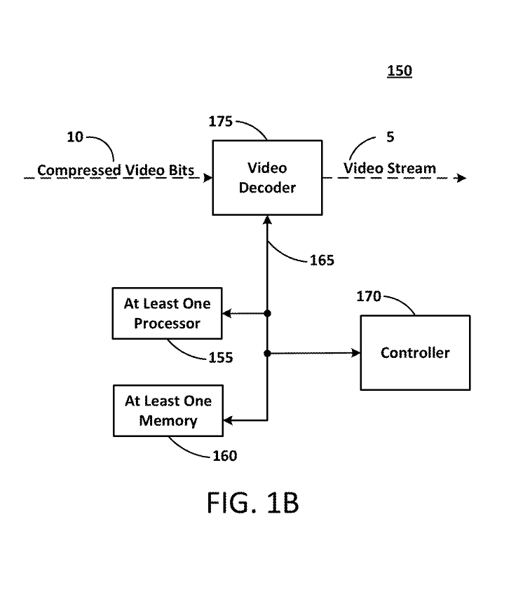

In the example of FIG. 1A, a video encoder system 100 may be, or include, at least one computing device and can represent virtually any computing device configured to perform the methods described herein. As such, the video encoder system 100 can include various components which may be utilized to implement the techniques described herein, or different or future versions thereof. By way of example, the video encoder system 100 is illustrated as including at least one processor 105, as well as at least one memory 110 (e.g., a non-transitory computer readable storage medium).

FIG. 1A illustrates the video encoder system according to at least one example embodiment. As shown in FIG. 1A, the video encoder system 100 includes the at least one processor 105, the at least one memory 110, a controller 120, and a video encoder 125. The at least one processor 105, the at least one memory 110, the controller 120, and the video encoder 125 are communicatively coupled via bus 115.

The at least one processor 105 may be utilized to execute instructions stored on the at least one memory 110, so as to thereby implement the various features and functions described herein, or additional or alternative features and functions. The at least one processor 105 and the at least one memory 110 may be utilized for various other purposes. In particular, the at least one memory 110 can represent an example of various types of memory and related hardware and software which might be used to implement any one of the modules described herein.

The at least one memory 110 may be configured to store data and/or information associated with the video encoder system 100. For example, the at least one memory 110 may be configured to store codecs associated with intra-prediction, filtering and/or mapping spherical video or images to 2D representations of the spherical video or images. The at least one memory 110 may be a shared resource. For example, the video encoder system 100 may be an element of a larger system (e.g., a server, a personal computer, a mobile device, and the like). Therefore, the at least one memory 110 may be configured to store data and/or information associated with other elements (e.g., image/video serving, web browsing or wired/wireless communication) within the larger system.

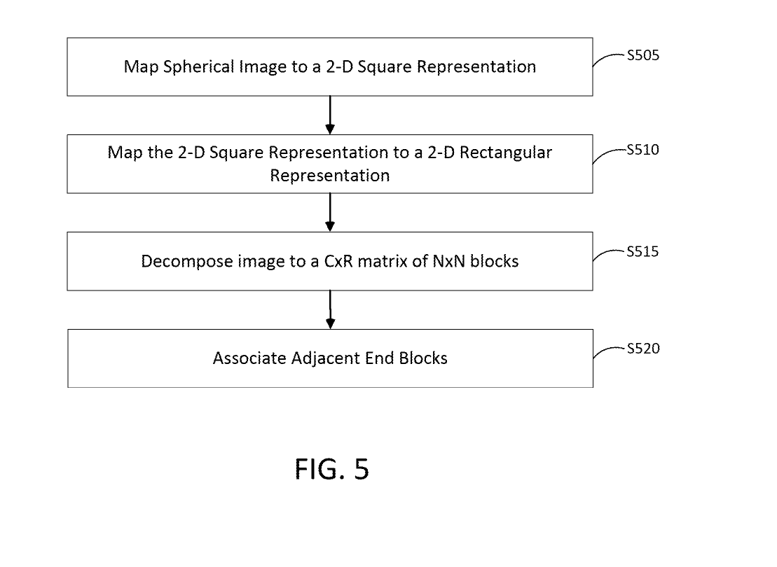

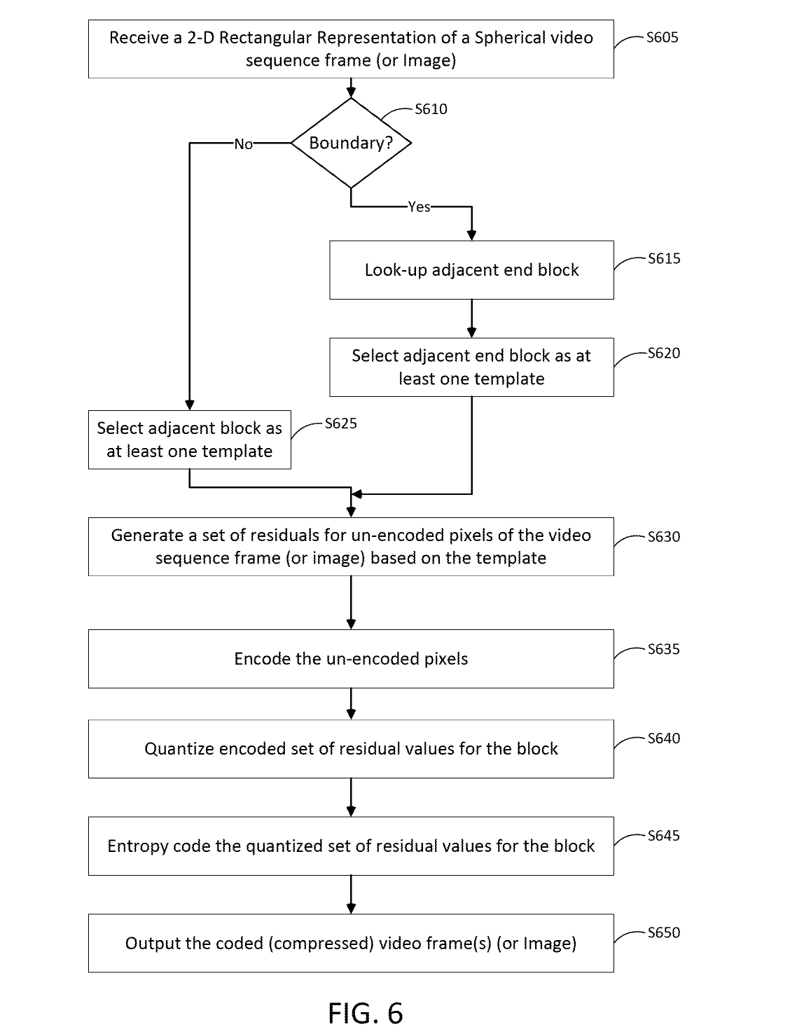

The controller 120 may be configured to generate various control signals and communicate the control signals to various blocks in video encoder system 100. The controller 120 may be configured to generate the control signals to implement the techniques described below. The controller 120 may be configured to control the video encoder 125 to encode an image, a sequence of images, a video frame, a video sequence, and the like according to example embodiments. For example, the controller 120 may generate control signals corresponding to inter-prediction, intra-prediction and/or mapping spherical video or images to 2D representations of the spherical video or images. More details related to the functions and operation of the video encoder 125 and controller 120 will be described below in connection with at least FIGS. 5, 6, 9A and 9B.

The video encoder 125 may be configured to receive a video stream input 5 and output compressed (e.g., encoded) video bits 10. The video encoder 125 may convert the video stream input 5 into discrete video frames. The video stream input 5 may also be an image, accordingly, the compressed (e.g., encoded) video bits 10 may also be compressed image bits. The video encoder 125 may further convert each discrete video frame (or image) into a C×R matrix of blocks (hereinafter referred to as blocks or as macroblocks). For example, a video frame (or image) may be converted to a matrix of 16×16, a 16×8, an 8×8, a 4×4 or a 2×2 blocks each having a number of pixels. Although five example matrices are listed, example embodiments are not limited thereto.

The compressed video bits 10 may represent the output of the video encoder system 100. For example, the compressed video bits 10 may represent an encoded video frame (or an encoded image). For example, the compressed video bits 10 may be ready for transmission to a receiving device (not shown). For example, the video bits may be transmitted to a system transceiver (not shown) for transmission to the receiving device.

The at least one processor 105 may be configured to execute computer instructions associated with the controller 120 and/or the video encoder 125. The at least one processor 105 may be a shared resource. For example, the video encoder system 100 may be an element of a larger system (e.g., a mobile device). Therefore, the at least one processor 105 may be configured to execute computer instructions associated with other elements (e.g., image/video serving, web browsing or wired/wireless communication) within the larger system.

In the example of FIG. 1B, a video decoder system 150 may be at least one computing device and can represent virtually any computing device configured to perform the methods described herein. As such, the video decoder system 150 can include various components which may be utilized to implement the techniques described herein, or different or future versions thereof. By way of example, the video decoder system 150 is illustrated as including at least one processor 155, as well as at least one memory 160 (e.g., a computer readable storage medium).

Thus, the at least one processor 155 may be utilized to execute instructions stored on the at least one memory 160, so as to thereby implement the various features and functions described herein, or additional or alternative features and functions. The at least one processor 155 and the at least one memory 160 may be utilized for various other purposes. In particular, the at least one memory 160 may represent an example of various types of memory and related hardware and software which might be used to implement any one of the modules described herein. According to example embodiments, the video encoder system 100 and the video decoder system 150 may be included in a same larger system (e.g., a personal computer, a mobile device and the like). The video decoder system 150 can be configured to perform the opposite or reverse operations of the encoder 100.

The at least one memory 160 may be configured to store data and/or information associated with the video decoder system 150. For example, the at least one memory 110 may be configured to store inter-prediction, intra-prediction and/or mapping spherical video or images to 2D representations of the spherical video or images. The at least one memory 160 may be a shared resource. For example, the video decoder system 150 may be an element of a larger system (e.g., a personal computer, a mobile device, and the like). Therefore, the at least one memory 160 may be configured to store data and/or information associated with other elements (e.g., web browsing or wireless communication) within the larger system.

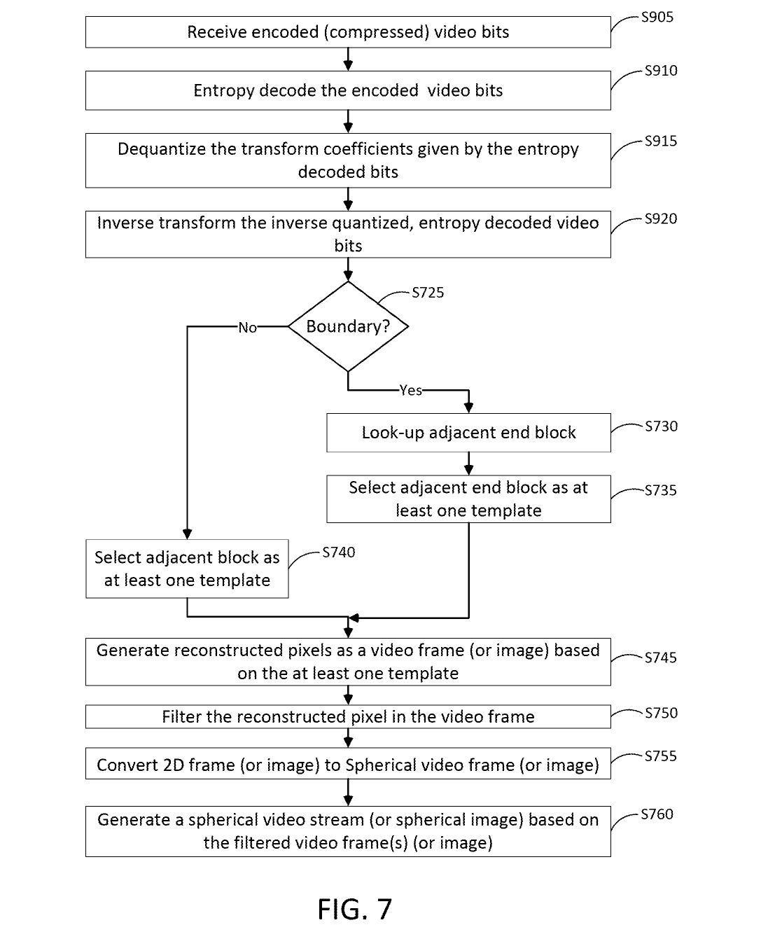

The controller 170 may be configured to generate various control signals and communicate the control signals to various blocks in video decoder system 150. The controller 170 may be configured to generate the control signals in order to implement the video decoding techniques described below. The controller 170 may be configured to control the video decoder 175 to decode a video frame according to example embodiments. The controller 170 may be configured to generate control signals corresponding to intra-prediction, filtering and/or mapping between spherical video and images to 2D representations of the spherical video or images. More details related to the functions and operation of the video decoder 175 and controller 170 will be described below in connection with at least FIGS. 7, 8, 9A and 9B.

The video decoder 175 may be configured to receive a compressed (e.g., encoded) video bits 10 input and output a video stream 5. The video decoder 175 may convert discrete video frames of the compressed video bits 10 into the video stream 5. The compressed (e.g., encoded) video bits 10 may also be compressed image bits, accordingly, the video stream 5 may also be an image.

The at least one processor 155 may be configured to execute computer instructions associated with the controller 170 and/or the video decoder 175. The at least one processor 155 may be a shared resource. For example, the video decoder system 150 may be an element of a larger system (e.g., a personal computer, a mobile device, and the like). Therefore, the at least one processor 155 may be configured to execute computer instructions associated with other elements (e.g., web browsing or wireless communication) within the larger system.

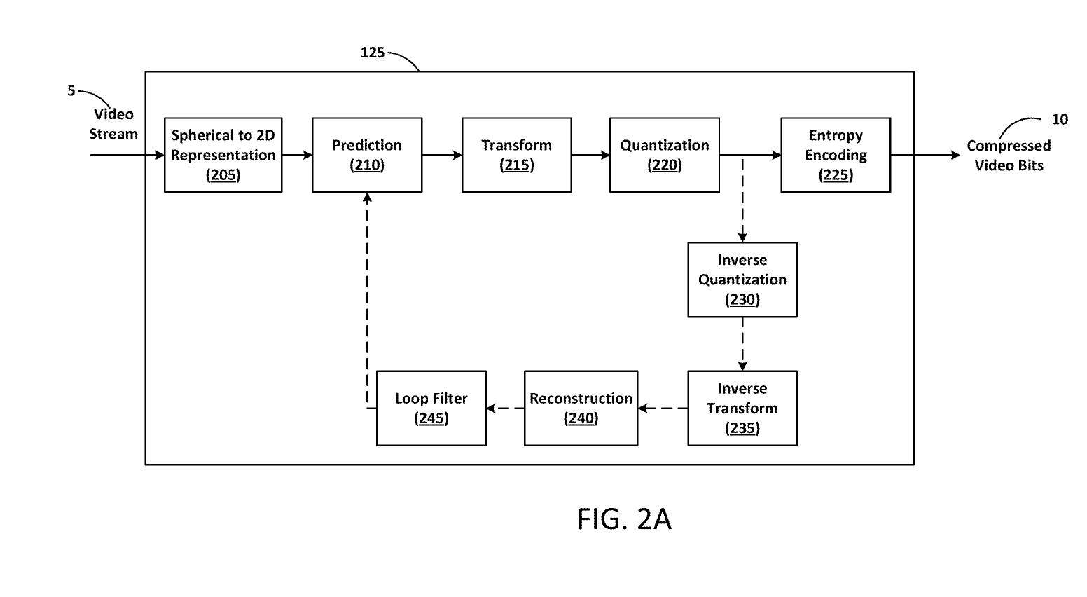

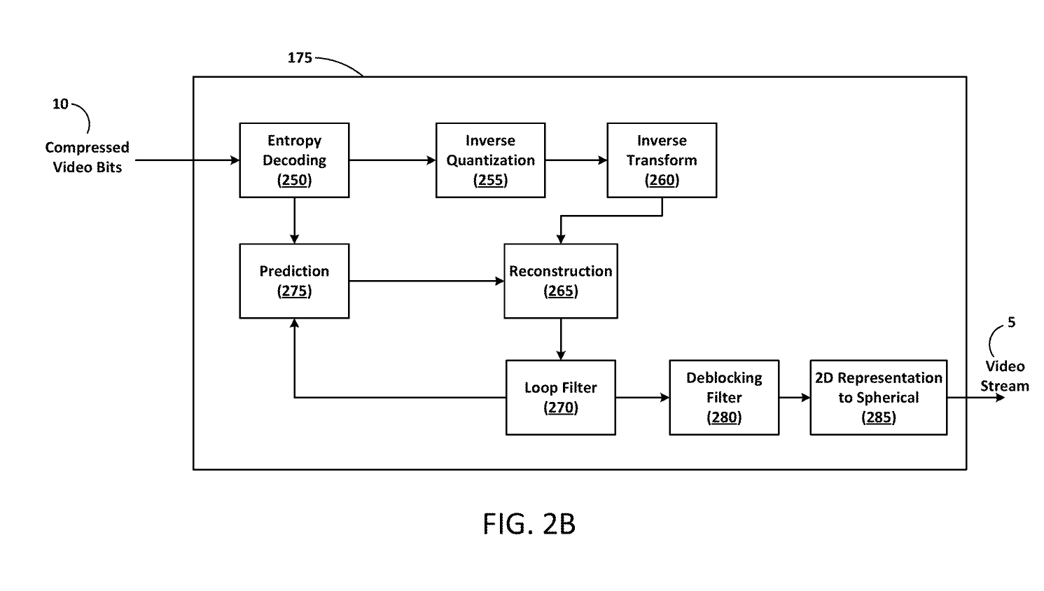

FIGS. 2A and 2B illustrate a flow diagram for the video encoder 125 shown in FIG. 1A and the video decoder 175 shown in FIG. 1B, respectively, according to at least one example embodiment. The video encoder 125 (described above) includes a spherical to 2D representation block 205, a prediction block 210, a transform block 215, a quantization block 220, an entropy encoding block 225, an inverse quantization block 230, an inverse transform block 235, a reconstruction block 240, and a loop filter block 245. Other structural variations of video encoder 125 can be used to encode input video stream 5. As shown in FIG. 2A, dashed lines represent a reconstruction path amongst the several blocks and solid lines represent a forward path amongst the several blocks.

Each of the aforementioned blocks may be executed as software code stored in a memory (e.g., at least one memory 110) associated with a video encoder system (e.g., as shown in FIG. 1A) and executed by at least one processor (e.g., at least one processor 105) associated with the video encoder system. However, alternative embodiments are contemplated such as a video encoder embodied as a special purpose processor. For example, each of the aforementioned blocks (alone and/or in combination) may be an application-specific integrated circuit, or ASIC. For example, the ASIC may be configured as the transform block 215 and/or the quantization block 220.

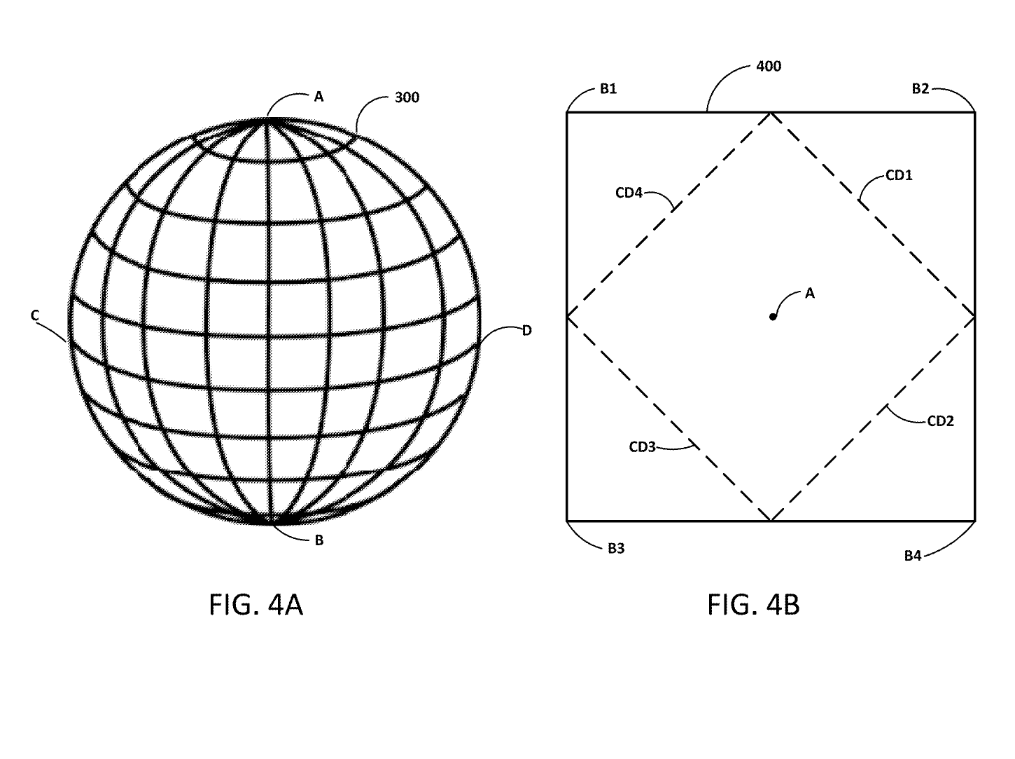

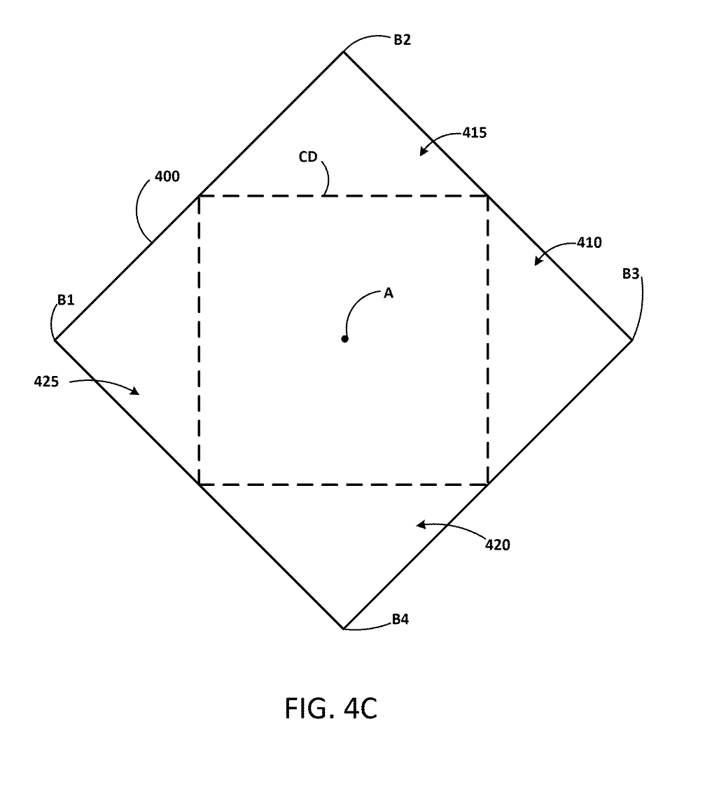

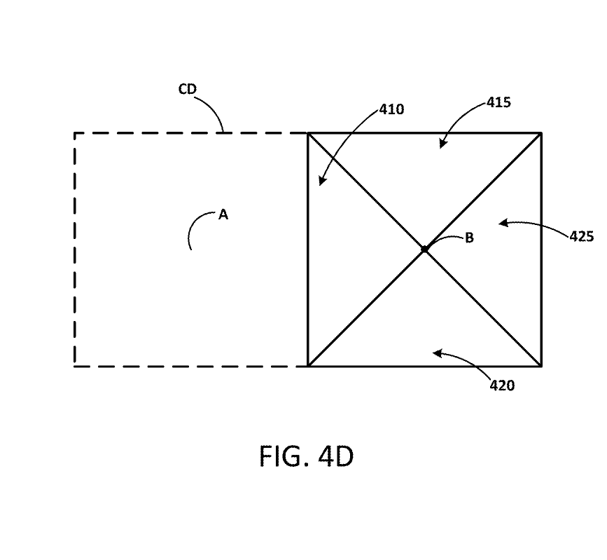

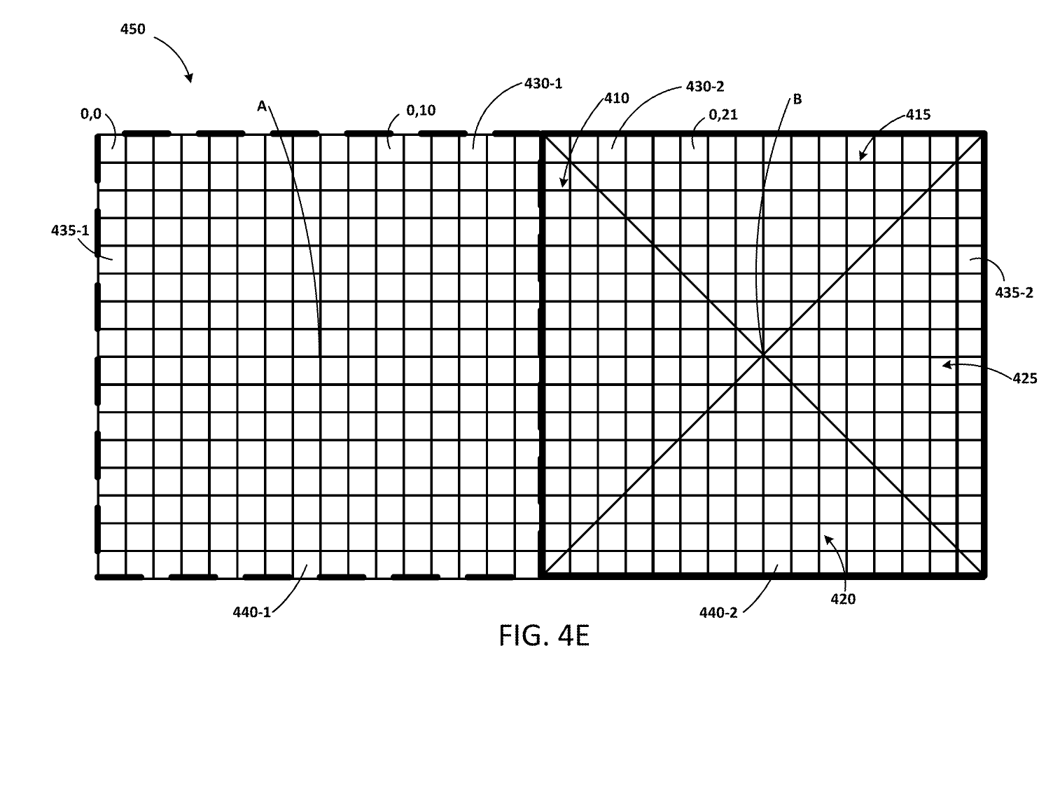

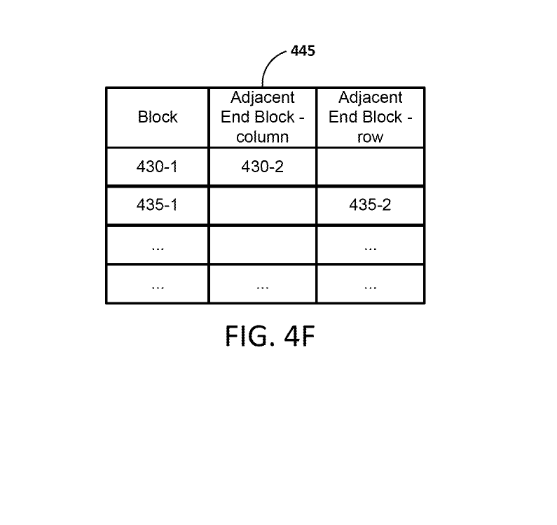

The spherical to 2D representation block 205 may be configured to map a spherical frame or image to a 2D representation of the spherical frame or image. For example, FIG. 4A illustrates a sphere 300 (e.g., as a frame or an image). The sphere 300 can be projected as a 2D square representation using an algorithm that maps a sphere to a 2D square. For example, sphere 300 can be projected as a 2D square representation using a Peirce quincuncial projection algorithm. In other words, the spherical to square projection can be a Peirce quincuncial projection. Mapping a spherical frame or image to a 2D representation of the spherical frame or image is described in more detail below with regard to FIG. 5.

The prediction block 210 may be configured to utilize video frame coherence (e.g., pixels that have not changed as compared to previously encoded pixels). Prediction may include two types. For example, prediction may include intra-frame prediction and inter-frame prediction. Intra-frame prediction (or an intra-prediction process) relates to predicting the pixel values in a block of a picture relative to reference samples in neighboring, previously coded blocks of the same picture. In intra-frame prediction, a sample is predicted from reconstructed pixels within the same frame for the purpose of reducing the residual error that is coded by the transform (e.g., entropy encoding block 225) and entropy coding (e.g., entropy encoding block 225) part of a predictive transform codec. Inter-frame prediction relates to predicting the pixel values in a block of a picture relative to data of at least one previously coded picture.

The transform block 215 may be configured to convert the values of the pixels from the spatial domain to transform coefficients in a transform domain. The transform coefficients may correspond to a two-dimensional matrix of coefficients that can be the same size as the original block. In other words, there may be as many transform coefficients as pixels in the original block. However, due to the transform, a portion of the transform coefficients may have values equal to zero.

The transform block 215 may be configured to transform the residual (from the prediction block 210) into transform coefficients in, for example, the frequency domain. The transforms can include the Karhunen-Loève Transform (KLT), the Discrete Cosine Transform (“DCT”), the Singular Value Decomposition Transform (“SVD”) and the asymmetric discrete sine transform (ADST).

The quantization block 220 may be configured to reduce the data in each transformation coefficient. Quantization may involve mapping values within a relatively large range to values in a relatively small range, thus reducing the amount of data needed to represent the quantized transform coefficients. The quantization block 220 may convert the transform coefficients into discrete quantum values, which are referred to as quantized transform coefficients or quantization levels. For example, the quantization block 220 may be configured to add zeros to the data associated with a transformation coefficient. For example, an encoding standard may define 128 quantization levels in a scalar quantization process.

The quantized transform coefficients are then entropy encoded by entropy encoding block 225. The entropy-encoded coefficients, together with the information required to decode the block, such as the type of prediction used, motion vectors and quantizer value, are then output as the compressed video bits 10. The compressed video bits 10 can be formatted using various techniques, such as run-length encoding (RLE) and zero-run coding.

The reconstruction path in FIG. 2A is present to ensure that both the video encoder 125 and the video decoder 175 (described below with regard to FIG. 2B) use the same reference frames to decode compressed video bits 10 (or compressed image bits). The reconstruction path performs functions that are similar to functions that take place during the decoding process that are discussed in more detail below, including inverse quantizing the quantized transform coefficients at the inverse quantization block 230 and inverse transforming the inverse quantized transform coefficients at the inverse transform block 235 in order to produce a derivative residual block (derivative residual). At the reconstruction block 240, the prediction block that was predicted at the prediction block 210 can be added to the derivative residual to create a reconstructed block. A loop filter 245 can then be applied to the reconstructed block to reduce distortion such as blocking artifacts.

The video encoder 125 described above with regard to FIG. 2A includes the blocks shown. However, example embodiments are not limited thereto. Additional blocks may be added based on the different video encoding configurations and/or techniques used. Further, each of the blocks shown in the video encoder 125 described above with regard to FIG. 2A may be optional blocks based on the different video encoding configurations and/or techniques used.

FIG. 2B is a schematic block diagram of a decoder 175 configured to decode compressed video bits 10 (or compressed image bits). Decoder 175, similar to the reconstruction path of the encoder 125 discussed previously, includes an entropy decoding block 250, an inverse quantization block 255, an inverse transform block 260, a reconstruction block 265, a loop filter block 270, a prediction block 275, a deblocking filter block 280 and a 2D representation to spherical block 285.

The data elements within the compressed video bits 10 can be decoded by entropy decoding block 250 (using, for example, Context Adaptive Binary Arithmetic Decoding) to produce a set of quantized transform coefficients. Inverse quantization block 255 dequantizes the quantized transform coefficients, and inverse transform block 260 inverse transforms (e.g., using a KLT, a SVD, a DCT or an ADST) the dequantized transform coefficients to produce a derivative residual that can be identical to that created by the reconstruction stage in the encoder 125.

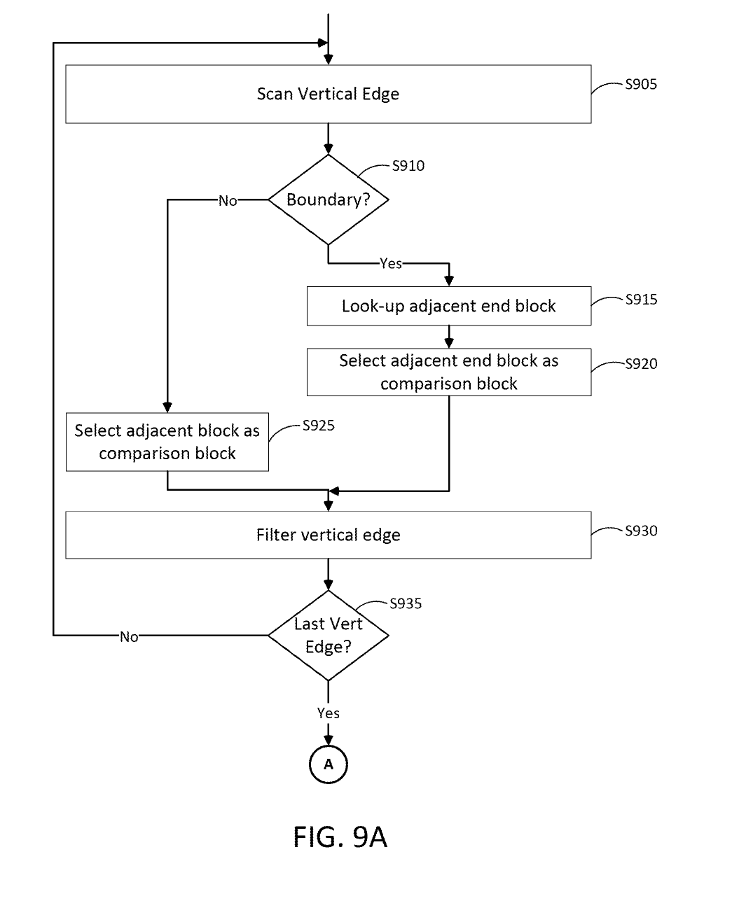

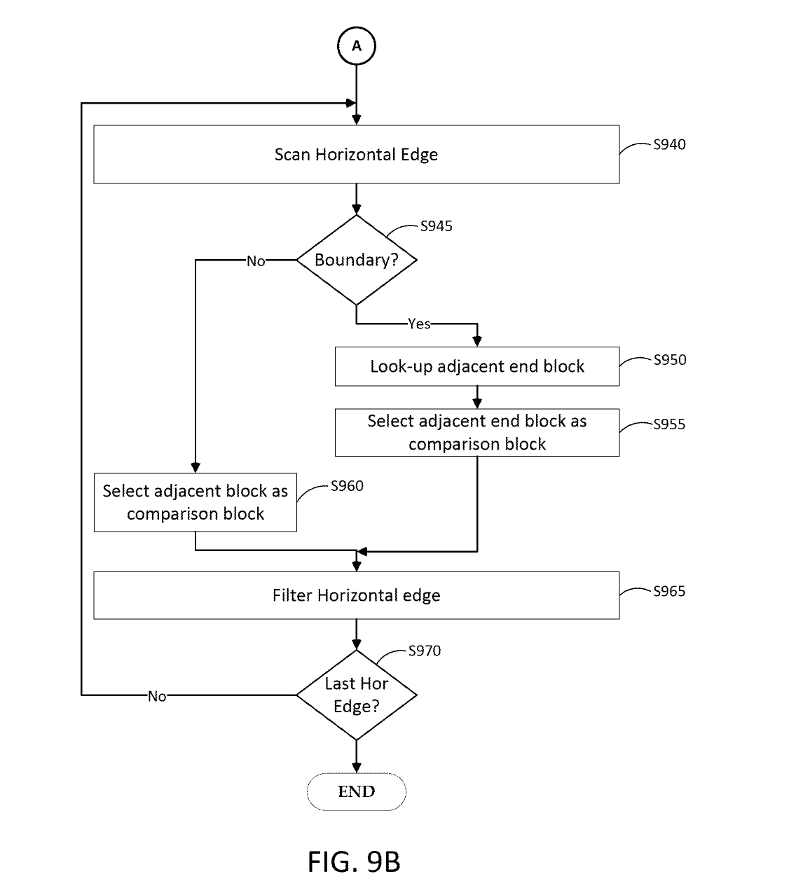

Using header information decoded from the compressed video bits 10, decoder 175 can use prediction block 275 to create the same prediction block as was created in encoder 125. The prediction block can be added to the derivative residual to create a reconstructed block by the reconstruction block 265. The loop filter block 270 can be applied to the reconstructed block to reduce blocking artifacts. Deblocking filter block 280 can be applied to the reconstructed block to reduce blocking distortion, and after converting the 2D frame or image to a spherical frame or image, he result is output as video stream 5. An example implementation of an operation of the deblocking filter 280 is described in more detail with regard to FIGS. 9A and 9B.

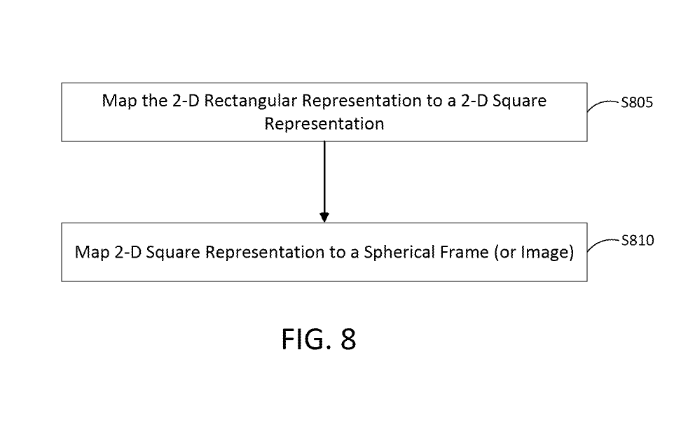

The 2D representation to spherical block 285 may be configured to map a 2D representation of a spherical frame or image to a spherical frame or image. For example, FIG. 4A illustrates the sphere 300 (e.g., as a frame or an image). The sphere 300 could have been previously projected using a projection algorithm. For example, sphere 300 can be projected as a 2D square representation using a Peirce quincuncial projection algorithm. Mapping a 2D representation of the spherical frame or image to a spherical frame or image is described in more detail below with regard to FIG. 8.

The video decoder 175 described above with regard to FIG. 2B includes the blocks shown. However, example embodiments are not limited thereto. Additional blocks may be added based on the different video encoding configurations and/or techniques used. Further, each of the blocks shown in the video decoder 175 described above with regard to FIG. 2B may be optional blocks based on the different video encoding configurations and/or techniques used.

The encoder 125 and the decoder 175 may be configured to encode spherical video and/or images and to decode spherical video and/or images, respectively. A spherical image is an image that includes a plurality of pixels spherically organized. In other words, a spherical image is an image that is continuous in all directions. Accordingly, a viewer of a spherical image can reposition (e.g., move her head or eyes) in any direction (e.g., up, down, left, right, or any combination thereof) and continuously see a portion of the image.

A spherical image can have perspective. For example, a spherical image could be an image of a globe. An inside perspective could be a view from a center of the globe looking outward. Or the inside perspective could be on the globe looking out to space. An outside perspective could be a view from space looking down toward the globe. As another example, perspective can be based on that which is viewable. In other words, a viewable perspective can be that which can be seen by a viewer. The viewable perspective can be a portion of the spherical image that is in front of the viewer. For example, when viewing from an inside perspective, a viewer could be lying on the ground (e.g., earth) and looking out to space. The viewer may see, in the image, the moon, the sun or specific stars. However, although the ground the viewer is lying on is included in the spherical image, the ground is outside the current viewable perspective. In this example, the viewer could turn her head and the ground would be included in a peripheral viewable perspective. The viewer could flip over and the ground would be in the viewable perspective whereas the moon, the sun or stars would not.

A viewable perspective from an outside perspective may be a portion of the spherical image that is not blocked (e.g., by another portion of the image) and/or a portion of the spherical image that has not curved out of view. Another portion of the spherical image may be brought into a viewable perspective from an outside perspective by moving (e.g., rotating) the spherical image and/or by movement of the spherical image. Therefore, the viewable perspective is a portion of the spherical image that is within a viewable range of a viewer of the spherical image.

A spherical image is an image that does not change with respect to time. For example, a spherical image from an inside perspective as relates to the earth may show the moon and the stars in one position. Whereas a spherical video (or sequence of images) may change with respect to time. For example, a spherical video from an inside perspective as relates to the earth may show the moon and the stars moving (e.g., because of the earths rotation) and/or an airplane streak across the image (e.g., the sky).

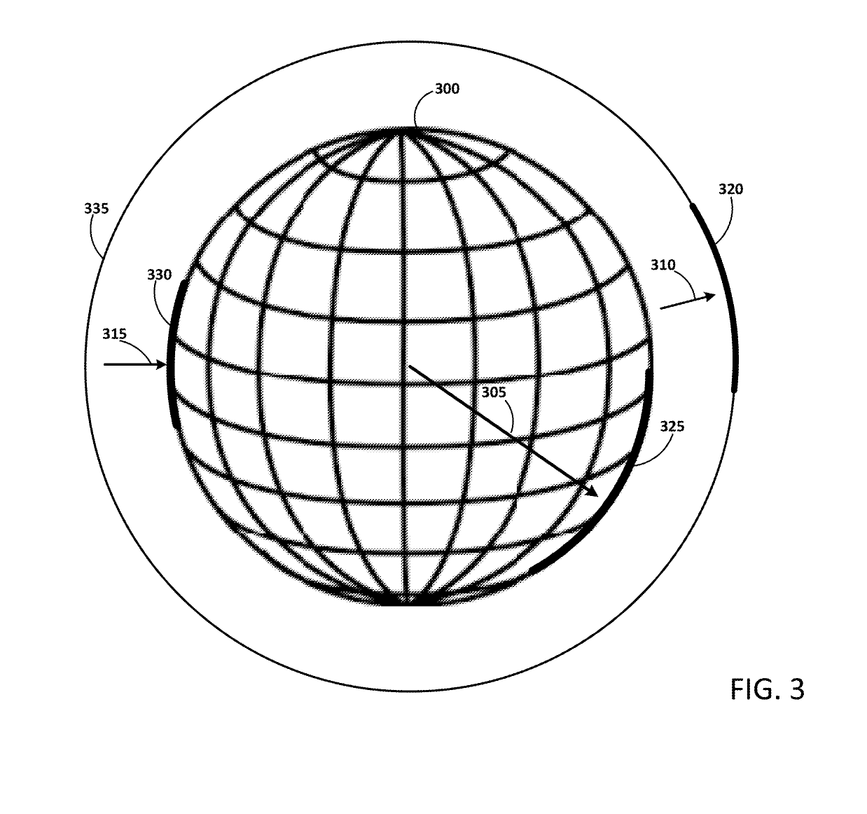

FIG. 3 illustrates a two dimensional (2D) representation of a sphere. As shown in FIG. 3, the sphere 300 (e.g., as a spherical image) illustrates a direction of inside perspective 305, 310, outside perspective 315 and viewable perspectives 320, 325, 330. The viewable perspective 320 may be a portion of a spherical image 335 as viewed from inside perspective 310. The viewable perspective 325 may be a portion of the sphere 300 as viewed from inside perspective 305. The viewable perspective 330 may be a portion of the sphere 300 as viewed from the outside perspective 315.

FIG. 4A further illustrates the sphere 300 as a spherical image according to at least one example embodiment. According to an example implementation, a line between points C and D can be equidistant between points or poles A and B. In other words, line between points C and D can be termed an equator (e.g., the sphere 300 as a globe) of the sphere 300. The line between points C and D can be projected onto a 2D shape (e.g., a square or rectangle).

FIGS. 4B and 4C illustrate a block diagram of a 2D square representation of a spherical video frame(s)/block(s) or image/block(s) according to at least one example embodiment. In the example of FIG. 4B, Pole A is mapped or projected to the center of square 400. Pole B is mapped or projected to the corners of square 400 and is illustrated as B1, B2, B3 and B4. The line CD1, CD2, CD3, CD4 between points C and D (or the equator) is shown as a rotated square (dashed lines) with respect to square 400. The corners of line CD1, CD2, CD3, CD4 intersect the sides of the square 400 equidistant from the corners B1, B2, B3, and B4. The projection of sphere 300 as a spherical video frame or image onto square 400 can be implemented using a Peirce quincuncial projection algorithm. It may be desirable to encode the 2D representation of the spherical video frame or image as a rectangle. In other words, many encoding standards are configured to encode a video frame or image that is a rectangle (e.g., a 2:1 side ratio). Therefore, in an example implementation, the 2D square representation of the spherical video frame or image can be mapped to a 2D rectangular representation of the spherical video frame or image. In some example implementations, additional processing can be performed to resize the 2D rectangular representation based on a desired encoding scheme.

FIG. 4C illustrates the projection of sphere 300 as a spherical video frame or image onto square 400 with square 400 rotated 45 degrees counterclockwise (square 400 could be rotated 45 degrees clockwise as well. Note, line CD1, CD2, CD3, CD4 between points C and D shown as a square (dashed lines) rotated with square 400. In FIG. 4D, the square 400 is illustrated after being mapped to a rectangle. The rectangle (as a second 2D representation) can be formed of two squares with equal length sides based on the square 400 (as a first 2D representation). The two squares can be generated from the square 400 (as the first 2D representation). A first square can have corners that intersect each side of the square 400 equidistant from the corners of the first two dimensional representation. A second square can be based on four triangles each having a side in contact with a different side of an inner circle of the frame of the spherical video. The second two dimensional representation can be based on the first square and the second square.

As shown in FIG. 4D, triangle 410 remains in the same position as in FIG. 4C, triangle 415 has been rotated clockwise, triangle 420 has been rotated counterclockwise, and triangle 425 has been rotated 180 degrees and extended to the right. Triangles 410, 415, 420 and 425 together make a square that is the same size as the square represented by dotted line CD1, CD2, CD3, CD4. In addition pole B is positioned in the center of the square formed by triangles 410, 415, 420 and 425. Together the square represented by dotted line CD1, CD2, CD3, CD4 and the square formed by triangles 410, 415, 420 and 425 form a rectangle with a length twice as long as a side. The square represented by dotted line CD1, CD2, CD3, CD4 and the square formed by triangles 410, 415, 420 and 425 are a 2D rectangular representation of the spherical video frame or image (e.g., of sphere 300).

FIG. 4D illustrates a block diagram of a 2D rectangle representation of a spherical video frame(s)/block(s) or image/block(s) according to at least one example embodiment. The 2D rectangle representation of a spherical video frame or image is shown as a decomposed image of a C×R matrix of N×N blocks. The C×R matrix is shown with a 2:1 ratio. The N×N blocks may be 2×2, 4×4, 8×8, 8×16, 16×16, and the like blocks (or blocks of pixels). Blocks 430-1, 430-2, 435-1, 435-2, 440-1 and 440-2 are shown in FIG. 4E as boundary blocks or on the boundary of the 2D rectangle representation. However, a spherical image is continuous and has no boundaries. Accordingly, the 2D rectangle representation does as well.

As discussed above, a spherical image is an image that is continuous in all directions. Accordingly, if the spherical image were to be decomposed into a plurality of blocks, the plurality of blocks would be contiguous over the spherical image. In other words, there are no edges or boundaries as in a 2D image. In example implementations, an adjacent end block may be a contiguous block to a block on a boundary of the 2D representation. In the example implementation shown in FIG. 4E, block 430-1 may be an adjacent end block for 430-2, block 435-1 may be an adjacent end block for 435-2, and block 440-1 may be an adjacent end block for 440-2. The opposite may also be the case. In other words, block 430-2 may be an adjacent end block for 430-1, block 435-2 may be an adjacent end block for 435-1, and block 440-2 may be an adjacent end block for 440-2.

Therefore, in any encoding scheme where an adjacent block is used, a block on a boundary of the 2D rectangle representation may have a corresponding adjacent end block located elsewhere in the 2D rectangle representation. FIG. 4F illustrates a look up table (LUT) according to at least one example embodiment. The LUT 445 may store references between corresponding boundary blocks and adjacent end blocks for the 2D rectangle representation. The LUT 445 is shown as storing block number indicators as, for example, 430-1 and 430-2 corresponding to each other. However, LUT 445 may store correspondences by x,y coordinates. For example, if the upper left hand corner is 0,0, block 0,10 may correspond (e.g., may be an adjacent end block for) to block 0,21.

FIGS. 5-9B are flowcharts of methods according to example embodiments. The steps described with regard to FIGS. 5-9B may be performed due to the execution of software code stored in a memory (e.g., at least one memory 110) associated with an apparatus (e.g., as shown in FIG. 1) and executed by at least one processor (e.g., at least one processor 105) associated with the apparatus. However, alternative embodiments are contemplated such as a system embodied as a special purpose processor. Although the methods described below are described as being executed by a processor, the methods (or portions thereof) are not necessarily executed by a same processor. In other words, at least one processor may execute the methods described below with regard to FIGS. 5-9B.

FIG. 5 is a flowchart of a method for mapping a spherical image to a 2D representation of the spherical image according to at least one example embodiment. As shown in FIG. 5, in step S505 a spherical image is mapped to a 2D square representation. For example, FIG. 4B illustrates the sphere 300 illustrated in FIG. 4A as a 2D square representation. The mapping can include mapping the image or a frame of a spherical video to a 2D representation based on a spherical to square projection. In this example, the 2D representation can be a square. The sphere 300 can be projected onto the 2D square representation using a projection algorithm. In one example implementation, the projection algorithm can be a Peirce quincuncial projection algorithm.

The Peirce quincuncial projection algorithm states a point P on the Earth's surface, a distance p from the North Pole with longitude θ and latitude λ is first mapped to a point (p, θ) of the plane through the equator, viewed as the complex plane with coordinate w; this w coordinate is then mapped to another point (x, y) of the complex plane (given the coordinate z) by an elliptic function of the first kind Using Gudermann's notation for Jacobi's elliptic functions, the relationships are:

$$tan ( \frac{p}{2} ) {e}^{iθ} = cn ( z , \frac{1}{2} ) \qquad ( 1 )$$

where,

w=pe^{iθ} and z=x+iy

Other square and/or rectangular projections are within the scope of this disclosure.

In step S510 the 2D square representation is mapped to a 2-D rectangular representation. The mapping can include mapping the 2D square representation to another (or second) 2D representation. The another 2D representation can be a rectangle. For example, FIG. 4B illustrates 2D square representation. In an example implementation, the 2D square representation can be rotated clockwise or counterclockwise (e.g., as in FIG. 4C). Triangles formed by the intersection of lines (forming a square) based on the equator of the sphere with the sides of the 2D square representation and equidistant from the corners of the 2D square representation can be repositioned to form another square that is the same size as the based on the equator of the sphere. Merging the square based on the triangles and the square based on the equator can form a rectangle with as side ratio of 2:1.

In step S515 the 2-D rectangular representation is decomposed to a C×R matrix of N×N blocks. For example, as shown in FIG. 4E, the 2D rectangular representation 450 is a 32×16 matrix of N×N blocks. The N×N blocks may be 2×2, 4×4, 8×8, 8×16, 16×16, and the like blocks (or blocks of pixels).

Accordingly, in step S520 adjacent end blocks are associated. For example, as discussed above, blocks 430-1, 430-2, 435-1, 435-2, 440-1 and 440-2 are shown as boundary blocks or on the boundary of the 2D rectangle representation. However, a spherical image is continuous and has no boundaries. Accordingly, the 2D rectangle representation does as well. In the example implementation shown in FIG. 4E, block 430-1 may be an adjacent end block for 430-2, block 435-1 may be an adjacent end block for 435-2, and block 440-1 may be an adjacent end block for 440-2. The opposite may also be the case. In other words, block 430-2 may be an adjacent end block for 430-1, block 435-2 may be an adjacent end block for 435-1, and block 440-2 may be an adjacent end block for 440-2. Therefore, the adjacent end blocks may be associated and stored in a lookup table (e.g., lookup table 445 as shown in FIG. 4C).

In the example implementation shown in FIG. 4E, the rectangular mapping gives an aspect ratio of 2×1 (equivalently 16×8). Encoding standards may utilize other aspect ratios. For example, At least one encoding standard may use an aspect ratio of 16×9. Accordingly, the 2D rectangular representation 450 can be resized (e.g., vertically) to an aspect ratio of 16×9.

Exploiting spatial redundancy between samples within a frame (e.g., frame, image, slice, group of macroblocks) is referred to as intra-prediction. Exploiting spatial redundancy for samples between frames (e.g., frame, image, slice, group of macroblocks) is referred to as inter-prediction. In intra-prediction a prediction block can be generated in response to previously encoded and reconstructed blocks in the same frame (or image). In inter-prediction a prediction block can be generated in response to previously encoded and reconstructed blocks in a different (e.g., sequentially previous in time or a base/template) frame. The prediction block is subtracted from the current block prior to encoding. For example, with luminance (luma) samples, the prediction block can be formed for each N×N (e.g., 4×4) sub-block or for a N×N (e.g., 16×16) macroblock. During encoding and/or decoding, the blocks or macroblocks can be sequentially coded within each frame or slice.

In intra-prediction, a coding pass can include sequentially coding blocks along a row (e.g., top to bottom), a column (e.g., left to right) or in a zig-zag pattern (e.g., starting from the upper left corner). In an intra-prediction coding pass, the blocks which are located above and to the left of the current block within the frame (or image), have been previously encoded and reconstructed. Accordingly, the blocks which are located above and to the left of the current block can be available to the encoder/decoder as a prediction reference. However, if the current block is in the upper left corner of a frame, then no previous blocks have been coded in the frame. Further, if the current block is in the upper row of a frame, then no neighbors above the current block have been coded. Still further, if the current block is in the left column of a frame, then no neighbors on the same row as the current block have been coded.

FIG. 7 is a flowchart of a method for encoding a video frame according to at least one example embodiment. As shown in FIG. 7, in step S605 a controller (e.g., controller 120) receives a 2-D rectangular representation of a spherical video sequence frame (or image) to encode. For example, the video encoder may receive a spherical video stream input 5, break the stream into a plurality of video frames, convert each frame to a 2-D rectangular representation (as discussed above with regard to FIG. 5) and select the first video frame. The controller may also set initial configurations. For example, the controller may set an intra-frame coding scheme or mode.

In step S610 whether or not the current block is at a frame (or image) boundary is determined. For example, in one example implementation, a C×R matrix of N×N blocks includes pixels in each block. Accordingly, blocks in row 0, column 0, row R−1 and column C−1 include pixels of the spherical image. Therefore, if, during a scan, the C×R matrix of blocks includes pixels in each block and the column/row=0 or the column/row=C−1/R−1, the block is at a boundary. If the block is at a boundary, processing moves to step S615. Otherwise, processing continues to step S625.

In step S615 an adjacent end block is looked-up (or identified or searched). For example, in one example implementation, a C×R matrix of blocks may have an associated LUT mapping boundary blocks to a corresponding adjacent end block. In this example column and row adjacent end blocks can be looked-up in a look-up table (e.g., LUT 445).

In step S620 an adjacent end block is selected as at least one template. For example, as discussed above, during intra-prediction a prediction block can be generated in response to previously encoded and reconstructed blocks in the same frame (or image). The previously encoded and reconstructed block(s) may be selected from adjacent blocks (e.g., a block that is above and/or to the left of the block to be encoded) as a template. In this case, the block to be encoded is on the end of a column and/or row in the C×R matrix. Accordingly, at least one of the adjacent blocks to be selected as a template can be one of the looked-up adjacent end blocks.

In step S625 an adjacent block is selected as at least one template. For example, the previously encoded and reconstructed block(s) may be selected from adjacent blocks (e.g., a block that is above and/or to the left of the block to be encoded) as a template. In this case, the block to be encoded is not on the end of a column and/or row in the C×R matrix. Accordingly, at least one of the adjacent blocks to be selected as a template can be selected from a block above and/or to the left of the block to be encoded.

In at least one example embodiment, more than one adjacent block can be selected for use as a template. For example, an adjacent block and a block adjacent (in the same direction) to the adjacent block can be selected (e.g., two blocks). The selected blocks can then be averaged to form a template block. In this example, it is possible for the template to be based on an adjacent block and an adjacent end block.

In step S630 a set of residuals for un-encoded pixels of the video sequence frame (or image) is generated based on the template. For example, at least one value associated with each pixel may be subtracted from a corresponding value associated with a corresponding block of the selected template.

In step S635 the un-encoded pixels are encoded. For example, the generated pixels may be transformed (encoded or compressed) into transform coefficients using a configured transform (e.g., a KLT, a SVD, a DCT or an ADST).

In step S640 the encoder quantizes the encoded set of residual values for the block. For example, the controller 120 may instruct (or invoke) the quantization block 220 to quantize coded motion vectors and the coded residual errors, through any reasonably suitable quantization techniques. In addition, at step S645, the controller 120 may instruct the entropy coding block 220 to, for example, assign codes to the quantized motion vector codes and residual error codes to match code lengths with the probabilities of the quantized motion vector codes and residual error codes, through any coding technique.

In step S650 the encoder outputs the coded (compressed) video frame(s). For example, the controller 120 may output the coded video (e.g., as coded video frames) to one or more output devices. The controller 120 may output the coded video as a single motion vector and a single set of predictor values (e.g., residual errors) for the macroblock. The controller 120 may output information indicating the mode or scheme use in intra-frame coding by the encoder. For example, the coded (compressed) video frame(s) may include a header for transmission. The header may include, amongst other things, the information indicating the mode or scheme use in intra-frame coding by the encoder. The intra-frame coding scheme or mode may be communicated with the coded (compressed) video frame(s) (e.g., in the header). The communicated intra-frame coding scheme or mode may indicate parameters used to convert each frame to a 2-D rectangular representation (e.g., a Peirce quincuncial projection as well as any equations or algorithms used). The communicated intra-frame coding scheme or mode may be numeric based (e.g., mode 101 may indicate Peirce quincuncial projection).

FIG. 7 is a flowchart of a method for decoding a video frame according to at least one example embodiment. As shown in FIG. 7, in step S705 a video decoder (e.g., video decoder 175) receives encoded (compressed) video bits (e.g., compressed video bits 10). For example, the encoded (compressed) video bits may be a previously encode (e.g., by video encoder 125) real time video spherical stream (e.g., a concert or sporting event recording) received via communication network (e.g., Internet or Intranet). For example, the video stream may also be a previously recorded video (e.g., a movie or a video recorder recording). The coded (compressed) video frame(s) may include a header for transmission. The header may include, amongst other things, the information indicating the mode or scheme use in intra-frame coding by the encoder. For example, the intra-frame coding scheme or mode may indicate parameters used to convert each frame to a 2-D rectangular representation (e.g., indicate a Peirce quincuncial projection as well as any equations or algorithms used).

In step S710 the video decoder entropy decodes the encoded video bits. For example, the compressed video bits can be decoded by entropy decoding using, for example, Context Adaptive Binary Arithmetic Decoding to produce a set of quantized transform coefficients. In step S715 the video decoder de-quantizes the transform coefficients given by the entropy decoded bits. For example, the entropy decoded video bits can be de-quantized by mapping values within a relatively small range to values in a relatively large range (e.g. opposite of the quantization mapping described above). Further, in step S720 the video decoder inverse transforms the video bits using an indicated (e.g., in the header) transform (e.g., a KLT, a SVD, a DCT or an ADST).

In step S725 whether or not the current block is at a frame (or image) boundary is determined. For example, in one example implementation, a C×R matrix of N×N blocks includes pixels in each block. Accordingly, blocks in row 0, column 0, row R−1 and column C−1 include pixels of the spherical image. Therefore, if, during a scan, the C×R matrix of blocks includes pixels in each block and the column/row=0 or the column/row=C−1/R−1, the block is at a boundary. If the block is at a boundary, processing moves to step S730. Otherwise, processing continues to step S740.

In step S730 an adjacent end block is looked-up. For example, in one example implementation, a C×R matrix of blocks may have an associated LUT mapping boundary blocks to a corresponding adjacent end block. In this example column and row adjacent end blocks can be looked-up in a look-up table (e.g., LUT 445).

In step S735 an adjacent end block is selected as at least one template. For example, as discussed above, during intra-prediction a prediction block can be generated in response to previously encoded and reconstructed blocks in the same frame (or image). The previously encoded and reconstructed block(s) may be selected from adjacent blocks (e.g., a block that is above and/or to the left of the block to be encoded) as a template. In this case, the block to be encoded is on the end of a column and/or row in the C×R matrix. Accordingly, at least one of the adjacent blocks to be selected as a template can be one of the looked-up adjacent end blocks.

In step S740 an adjacent block is selected as at least one template. For example, the previously encoded and reconstructed block(s) may be selected from adjacent blocks (e.g., a block that is above and/or to the left of the block to be encoded) as a template. In this case, the block to be encoded is not on the end of a column and/or row in the N×N matrix. Accordingly, at least one of the adjacent blocks to be selected as a template can be selected from a block above and/or to the left of the block to be encoded.

In at least one example embodiment, more than one adjacent block can be selected for use as a template. For example, an adjacent block and a block adjacent (in the same direction) to the adjacent block can be selected (e.g., two blocks). The selected blocks can then be averaged to form a template block. In this example, it is possible for the template to be based on an adjacent block and an adjacent end block.

In step S745 the video decoder generates reconstructed pixels as a video frame based on the matched template and the decoded video bits. For example, the video decoder may add the residuals (e.g., transformed or decompressed video bits) to the corresponding position in the matched template resulting in a reconstructed pixel.

In step S750 the video decoder filters the reconstructed pixel in the video frame. For example, a loop filter can be applied to the reconstructed block to reduce blocking artifacts. For example, a deblocking filter (e.g., as described below with regard to FIGS. 9A and 9B) can be applied to the reconstructed block to reduce blocking distortion.

In step S755 the 2D frame (or image) is converted to a spherical video frame (or image). For example, the 2D frame can be converted using the inverse of the technique described above with regard to mapping a spherical frame (or image) to a 2D representation of the spherical frame (or image). An example technique is described in more detail below with regard to FIG. 8.

In step S760 the video decoder generates a spherical video stream (or spherical image) based on the video frame(s). For example, at least one video frame of reconstructed converted pixels may be organized in a sequence to form a spherical video stream.

FIG. 8 is a flowchart of a method for converting a 2D representation of a spherical image to a spherical frame/image according to at least one example embodiment. As shown in FIG. 8, in step S805 the 2-D rectangular representation is mapped to a 2-D square representation. For example, as shown in FIGS. 4C and 4D, square a square can be mapped to a rectangle formed of two equal sized squares. One of the equal sized squares can be partitioned into four triangles each having a side of the square. Accordingly, an inverse mapping can be performed by repositioning three of four triangles to form a third square as the second two dimensional representation. In an example implementation, triangle 415 can be rotated counterclockwise, triangle 420 can be rotated clockwise and triangle 425 can be rotated 180 degrees. Each of triangles 415, 420 and 425 can be rotated and positioned as shown in FIG. 4C.

In step S810 the 2D square representation is mapped to a spherical frame (or image). For example, the Peirce quincuncial projection algorithm can be used to convert the 2D square representation to a spherical frame. For example, equation 1 can be used to generate spherical coordinates for pixels in the spherical frame based on the x,y coordinates of corresponding pixels in the 2D square representation.

FIGS. 9A and 9B are flowcharts for a method of operating a deblocking filter according to at least one example embodiment. Quantization may introduce blocky artifacts in reconstructed image. The deblocking filter may be configured to smooth the edges between transform blocks. Vertical edges are deblocked first, then horizontal edges are deblocked (however, this order may be different in different implementations). The deblocking filter can be content-adaptive. In other words, the deblocking filter width (e.g., number of pixels deblocked) depends on artifact (or distortion) width or height. Edges can be processed pixel by pixel such that 8, 4, 2 or 1 pixels on either side of the edge are deblocked. The deblocking filter searches for flatness and a distinct step in brightness over the edge. Typically, the boundary of an image, a frame or a slice are not deblocked because there is no comparison block in a 2D image, frame or slice. However, in example embodiments, the image, frame or slice is a spherical image, frame or slice. Accordingly, there are no boundaries as in a 2D image, frame or slice.

As shown in FIG. 9A, in step S905 a vertical edge is scanned. For example, a scan can begin in the upper left corner (0,0) of the decoded frame. The scan can move down the column until reaching row R−1. Then the scan can begin again at row 0 and work down or scan in a down-up-down sequence. Each scanning of a vertical edge may include one or more blocks.

In step S910 whether or not the current block is at a frame (or image) boundary is determined. For example, in one example implementation, a C×R matrix of N×N blocks includes pixels in each block. Accordingly, blocks in row 0, column 0, row R−1 and column C−1 include pixels of the spherical image. Therefore, if, during a vertical scan, the C×R matrix of blocks includes pixels in each block and the column=0 or column=C−1, the block is at a boundary. Further in a vertical scan, the blocks to be scanned could be on the left of the block to be processed or the left of the block to be processed. Therefore, if scanning with a left processing orientation, column 0 may include boundary blocks. If scanning with a right processing orientation, column C−1 may include boundary blocks. If scanning with a dual processing orientation, columns 0 and C−1 may include boundary blocks. If the block is at a boundary, processing moves to step S915. Otherwise, processing continues to step S925.

In step S915 an adjacent end block is looked-up. For example, in one example implementation, a C×R matrix of blocks may have an associated LUT mapping boundary blocks to a corresponding adjacent end block. In this example column and row adjacent end blocks can be looked-up in a look-up table (e.g., LUT 445).

In step S920 an adjacent end block is selected as a comparison block. For example, as discussed above, during deblocking filtering pixels across an edge of two blocks can be filtered to remove blocky transitions. The comparison block (for a scanned vertical edge block) may be selected from adjacent block(s) (e.g., to the left of the block including the vertical edge to be filtered) as a comparison block. In this case, the block including the vertical edge to be filtered is on an end column in the C×R matrix of the frame (or image). Accordingly, at least one of the adjacent blocks to be selected as a comparison block can be one of the looked-up adjacent end blocks. In other words, the adjacent block to be selected as a comparison block can be other than a left reconstructed block compared to the block to be deblocked.

In step S925 an adjacent block is selected as a comparison block. For example, as discussed above, during deblocking filtering pixels across an edge of two blocks can be filtered to remove blocky transitions. The comparison block (for a scanned vertical edge block) may be selected from adjacent block(s) (e.g., to the left of the block including the vertical edge to be filtered) as a comparison block. In this case, the block including the vertical edge to be filtered is not on an end column in the C×R matrix of the frame (or image). Accordingly, at least one of the adjacent blocks to be selected as a comparison block can be selected from a block in an adjacent (e.g., to the left) column.

In step S930 the vertical edge is filtered. For example, as discussed above, the deblocking filter width (e.g., number of pixels deblocked) can depend on artifact (or distortion) width. Therefore, a number of pixels from the block including the vertical edge to be filtered (e.g., 1, 2, 4 or 8) is selected and a corresponding number of from the comparison block are selected. The pixels are then filtered. The filtering (or deblocking) may include, for example, a low pass filter (e.g., to reduce brightness over the edge), applying a regression algorithm over the selected pixels, applying a wavelet-based algorithm over the selected pixels, applying a anisotropic diffusion based algorithm over the selected pixels, and/or performing a weighted sum of pixels over the selected pixels. In any case, deblocking can be performed across block boundaries.

In step S935 whether or not the current block is the last vertical block is determined. For example, if scanning began at block 0,0, the last block may be block C−1,R−1. If the block is the last vertical block, processing moves to step S940. Otherwise, processing returns to step S905.

In step S940 a horizontal edge is scanned. For example, a scan can begin in the upper left corner (0,0) of the decoded frame. The scan can move along (to the right) a until reaching column C−1. Then the scan can begin again at column 0 and work to the right or scan in a right-left-right sequence. Each scanning of a horizontal edge may include one or more blocks.

In step S945 whether or not the current block is at a frame (or image) boundary is determined. For example, in one example implementation, a C×R matrix of N×N blocks includes pixels in each block. Accordingly, blocks in row 0, column 0, row R−1 and column C−1 include pixels of the spherical image. Therefore, if, during a horizontal scan, the C×R matrix of blocks includes pixels in each block and the row=0 or row=R−1, the block is at a boundary. If the block is at a boundary, processing moves to step S950. Otherwise, processing continues to step S960.

In step S950 an adjacent end block is looked-up. For example, in one example implementation, a C×R matrix of blocks may have an associated LUT mapping boundary blocks to a corresponding adjacent end block. In this example column and row adjacent end blocks can be looked-up in a look-up table (e.g., LUT 445).

In step S955 an adjacent end block is selected as a comparison block. For example, as discussed above, during deblocking filtering pixels across an edge of two blocks can be filtered to remove blocky transitions. The comparison block (for a scanned horizontal edge block) may be selected from adjacent block(s) (e.g., above the block including the horizontal edge to be filtered) as a comparison block. In this case, the block including the horizontal edge to be filtered is on a top or bottom row in the C×R matrix of the frame (or image). Accordingly, at least one of the adjacent blocks to be selected as a comparison block can be one of the looked-up adjacent end blocks. In other words, the adjacent block to be selected as a comparison block can be other than a upper reconstructed block compared to the block to be deblocked.

In step S960 an adjacent block is selected as a comparison block. For example, as discussed above, during deblocking filtering pixels across an edge of two blocks can be filtered to remove blocky transitions. The comparison block (for a scanned horizontal edge block) may be selected from adjacent block(s) (e.g., above the block including the horizontal edge to be filtered) as a comparison block. In this case, the block including the horizontal edge to be filtered is not on a top or bottom row in the C×R matrix of the frame (or image). Accordingly, at least one of the adjacent blocks to be selected as a comparison block can be selected from a block in an adjacent (e.g., above) TOW.

In step S965 the horizontal edge is filtered. For example, as discussed above, the deblocking filter width (e.g., number of pixels deblocked) can depend on artifact (or distortion) height. Therefore, a number of pixels from the block including the horizontal edge to be filtered (e.g., 1, 2, 4 or 8) is selected and a corresponding number of from the comparison block are selected. The pixels are then filtered. The filtering (or deblocking) may include, for example, a low pass filter (e.g., to reduce brightness over the edge), applying a regression algorithm over the selected pixels, applying a wavelet-based algorithm over the selected pixels, applying a anisotropic diffusion based algorithm over the selected pixels, and/or performing a weighted sum of pixels over the selected pixels. In any case, deblocking can be performed across block boundaries.

In step S970 whether or not the current block is the last horizontal block is determined. For example, if scanning began at block 0,0, the last block may be block C−1,R−1. If the block is the last horizontal block, the deblocking process ends. Otherwise, processing returns to step S940.

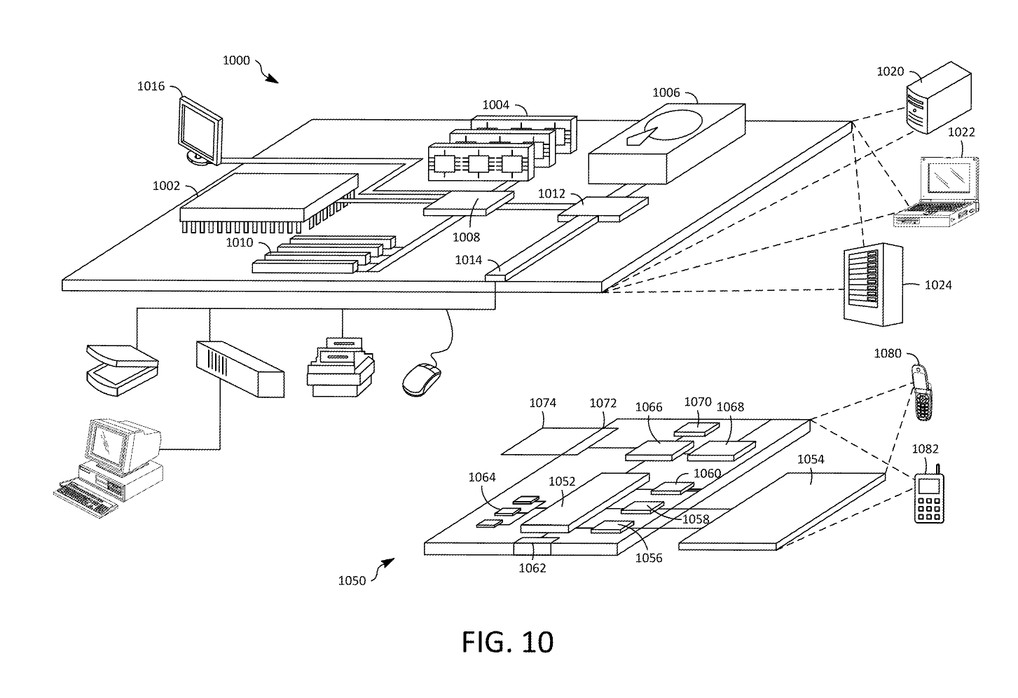

As will be appreciated, the system 100 and 150 illustrated in FIGS. 1A and 1B may be implemented as an element of and/or an extension of the generic computer device 1000 and/or the generic mobile computer device 1050 described below with regard to FIG. 10. Alternatively, or in addition to, the system 100 and 150 illustrated in FIGS. 1A and 1B may be implemented in a separate system from the generic computer device 1000 and/or the generic mobile computer device 1050 having some or all of the features described below with regard to the generic computer device 1000 and/or the generic mobile computer device 1050.

FIG. 10 is a schematic block diagram of a computer device and a mobile computer device that can be used to implement the techniques described herein. FIG. 10 is an example of a generic computer device 1000 and a generic mobile computer device 1050, which may be used with the techniques described here. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface 1008 connecting to memory 1004 and high-speed expansion ports 1010, and a low speed interface 1012 connecting to low speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high speed interface 1008. In other implementations, multiple processors and/or multiple buses may be used, as appropriate, along with multiple memories and types of memory. Also, multiple computing devices 1000 may be connected, with each device providing partitions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high speed controller 1008 manages bandwidth-intensive operations for the computing device 1000, while the low speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed expansion port 1014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 1050. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052, that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, WiFi, or other such transceiver (not shown). In addition, GPS (Global Positioning System) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, or other similar mobile device.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method, comprising:
mapping a frame of a spherical video to a first two dimensional representation based on a spherical to square projection, the first two dimensional representation being a square;
mapping the first two dimensional representation to a second two dimensional representation, the second two dimensional representation being a rectangle; and
encoding the second two dimensional representation as an encoded bit stream.

2. The method of claim 1, wherein the spherical to square projection is a Peirce quincuncial projection.

3. The method of claim 1, during an intra-prediction process, the method further comprising:
determining whether a block to be encoded is on a boundary of the second two dimensional representation; and
upon determining the block to be encoded is on the boundary, select an adjacent end block as a template, the adjacent end block being other than a left reconstructed block or an upper reconstructed block of the block to be encoded.

4. The method of claim 1, the method further comprising:
determining whether a block to be deblocked is on a boundary of the two dimensional representation; and
upon determining the block to be deblocked is on the boundary, select an adjacent end block as a comparison block, the adjacent end block being other than a left reconstructed block or an upper reconstructed block of to the block to be deblocked.

5. The method of claim 1, wherein
the second two dimensional representation is formed of two squares with equal length sides, and
the two squares generated from the first two dimensional representation.

6. The method of claim 1, wherein the mapping of the first two dimensional representation to the second two dimensional representation includes:
determining a first square with corners that intersect each side of the first two dimensional representation equidistant from the corners of the first two dimensional representation;
determining four triangles each having a side in contact with a different side of an inner circle of the frame of the spherical video;
generating a second square based on the four triangles; and
generating the second two dimensional representation based on the first square and the second square.

7. The method of claim 1, further comprising:
generating a look-up table indicating a position of at least one corresponding adjacent end block.

8. The method of claim 1, wherein the encoding of the second two dimensional representation includes:
generating at least one residual by subtracting a template from un-encoded pixels of the block to be encoded;
encoding the at least one residual by applying a transform to a residual block including the at least one residual;
quantizing transform coefficients associated with the encoded at least one residual;
entropy encoding the quantized transform coefficients as a compressed video bit stream; and
transmitting the compressed video bit stream including a header indicating a intra-frame coding mode, the intra-frame coding mode indicating a technique used during the mapping of the frame of the spherical video to the two dimensional representation.

9. A method, comprising:
receiving an encoded bit stream including a header indicating a projection technique used during a conversion of a frame of a spherical video to a first two dimensional representation;
decoding the first two dimensional representation;
mapping the first two dimensional representation to a second two dimensional representation, the first two dimensional representation being a rectangle and the second two dimensional representation being a square; and
mapping the second two dimensional representation to a frame of the spherical video based on a spherical to square projection.

10. The method of claim 9, wherein the spherical to square projection is a Peirce quincuncial projection.

11. The method of claim 9, during an intra-prediction process, the method further comprising:
determining whether a block to be decoded is on a boundary of the first two dimensional representation; and
upon determining the block to be decoded is on the boundary, select an adjacent end block as a template, the adjacent end block being other than a left reconstructed block or an upper reconstructed block of the block to be encoded.

12. The method of claim 9, the method further comprising:
determining whether a block to be deblocked is on a boundary of the two dimensional representation; and
upon determining the block to be deblocked is on the boundary, select an adjacent end block as a comparison block, the adjacent end block being other than a left reconstructed block or an upper reconstructed block of to the block to be deblocked.

13. The method of claim 9, wherein
the first two dimensional representation is formed of two squares with equal length sides.

14. The method of claim 9, wherein the mapping of the first two dimensional representation to the second two dimensional representation includes:
generating a first square and a second square based on the first two dimensional representation;
determining four triangles from the second square each of the triangles having a side of the second square; and
repositioning three of the four triangles to form a third square as the second two dimensional representation.

15. The method of claim 9, further comprising:
generating a look-up table indicating a position of at least one corresponding adjacent end block.

16. The method of claim 9, wherein the decoding of the first two dimensional representation includes:
entropy decoding the encoded bit stream to generate quantized encoded transform coefficients;
de-quantizing the quantized encoded transform coefficients to generate encoded transform coefficients;
applying a transform to the encoded transform coefficients to generate at least one reconstructed prediction residual; and
adding the at least one reconstructed prediction residual to a prediction block associated with the matched template to reconstruct a pixel block.

17. A non-transitory computer-readable storage medium having stored thereon computer executable program code which, when executed on a computer system, causes the computer system to perform steps comprising:
mapping a frame of a spherical video to a first two dimensional representation based on a spherical to square projection, the first two dimensional representation being a square;
mapping the first two dimensional representation to a second two dimensional representation, the second two dimensional representation being a rectangle; and
encoding the second two dimensional representation as an encoded bit stream.

18. The non-transitory computer-readable storage medium of claim 17, during an intra-prediction process, the steps further comprising:
determining whether a block to be encoded is on a boundary of the second two dimensional representation; and
upon determining the block to be encoded is on the boundary, select an adjacent end block as a template, the adjacent end block being other than a left reconstructed block or an upper reconstructed block of the block to be encoded.

19. The non-transitory computer-readable storage medium of claim 17, the steps further comprising:
determining whether a block to be deblocked is on a boundary of the two dimensional representation; and
upon determining the block to be deblocked is on the boundary, select an adjacent end block as a comparison block, the adjacent end block being other than a left reconstructed block or an upper reconstructed block of to the block to be deblocked.

20. The non-transitory computer-readable storage medium of claim 17, wherein the mapping of the first two dimensional representation to the second two dimensional representation includes:
determining a first square with corners that intersect each side of the first two dimensional representation equidistant from the corners of the first two dimensional representation;
determining four triangles each having a side in contact with a different side of an inner circle of the frame of the spherical video;
generating a second square based on the four triangles; and
generating the second two dimensional representation based on the first square and the second square.
